(19) United States
(12) Patent Application Publication
(10) Pub. No.: US 2024/0046313 A1
(43) Pub. Date: Feb. 8, 2024

(54) PACING THE DELIVERY OF CONTENT CAMPAIGNS IN AN ONLINE CONCIERGE SYSTEM USING CROSS-RETAILER INVENTORY STOCK LEVELS

(71) Applicant: Maplebear Inc. (dba Instacart), San Francisco, CA (US)

(72) Inventors: Luis Manrique, New York, NY (US); Aamir Poonawalla, Dallas, TX (US); Amin Akbari, San Francisco, CA (US); Shesh Nath Mishra, San Jose, CA (US); Eitan Pinhas Teruzzi Katznelson, Lafayette, CA (US)

(21) Appl. No.: 17/877,748

(22) Filed: Jul. 29, 2022

(51) Int. Cl. G06Q 30/02; G06Q 10/08; G06Q 30/08

(52) U.S. Cl. CPC G06Q 30/0272; G06Q 10/087; G06Q 30/08

(57) ABSTRACT

An online concierge system facilitates procurement and delivery of items for customers using a network of shoppers. The online concierge system includes a promotion management engine that paces delivery of promotions for content campaigns based in part on predicted item availability and a paced spending model that operates to pace spending of a content campaign over a budget period. The system paces the delivery by determining whether to enter a bid for the impression opportunity by comparing an observed cumulative spend for the content campaign during a portion of the budget period prior to the impression time and a desired cumulative spend for the content campaign during the portion of the budget period prior to the impression time based on the distribution of impression opportunities and a budget for the content campaign during the budget period.

### BACKGROUND

This disclosure relates generally to an online concierge system for managing procurement and delivery of items to customers and more specifically to pacing participation in content campaigns in an online concierge system based on item availability.

Content campaigns in online applications are often controlled by digital auctions that collect bids from content providers and determine what content to send to users based at least in part on the bids. In the absence of specific controls on the submission of bids, such auctions often result in inefficiencies that can be detrimental to both the content providers and the customers the content providers are trying to reach.

### SUMMARY

In accordance with one or more aspects of the disclosure, an online concierge system processes requests from customers via a customer application, assigns the requests to available shoppers, and generates routing instructions via a shopper application for facilitating deliveries by the shoppers to the customers in accordance with the requests. The online concierge system includes a promotion management engine that paces delivery of promotions for content campaigns based in part on predicted item availability. An item availability model is obtained that is trained to predict availability likelihoods of items in an inventory of the online concierge system. In an embodiment, the item availability model is trained based on historical item availability data associated with items from a plurality of warehouses across a geographic area. An impression opportunity is identified for a content campaign to promote an item associated with the content campaign at an impression time within an impression time window. Based on the item availability model, a predicted item availability is predicted for the item at the impression time. A bid decision is determined for the impression opportunity dependent on the predicted item availability and a paced spending model that operates to pace a spending budget associated with the content campaign over a budget period (for example, a daily budget period). The content campaign enters a bid for the item responsive to a positive participation decision.

In an embodiment, the promotion management engine predicts, for the content campaign, a distribution of impression opportunities for available items in each of a plurality of budget sub-periods during the budget period. In an embodiment, the distribution of the impression opportunities comprises respective predicted proportions of total impression opportunities occurring in each of the budget sub-periods. The distribution of impression opportunities may be based on historical data indicative of historical impression opportunities and/or external factors.

An observed cumulative spend is obtained for the content campaign during a portion of the budget period prior to the impression time. A desired cumulative spend is determined for the content campaign during the portion of the budget period prior to the impression time based on the distribution of impression opportunities and a budget for the content campaign during the budget period. The bid decision is generated based on a comparison between the observed cumulative spend and the desired cumulative spend.

In an embodiment, determining the desired cumulative spend comprises determining, based on the distribution of impression opportunities, a cumulative density function representing a proportion of impression opportunities for the budget period predicted to occur prior to the impression time, and determining the desired cumulative spend as a product of the budget for the budget period and the cumulative density function.

### BRIEF DESCRIPTION OF THE DRAWINGS

FIG. 1 is a block diagram of a system environment in which an online system, such an online concierge system, operates, according to one or more embodiments.

FIG. 2 illustrates an environment of an online shopping concierge service, according to one or more embodiments.

FIG. 3 is a diagram of an online shopping concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 is a block diagram of a promotion management engine, according to one or more embodiments.

FIG. 6 is a flowchart illustrating an example embodiment of a process for pacing participation in content campaigns in an online concierge system.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

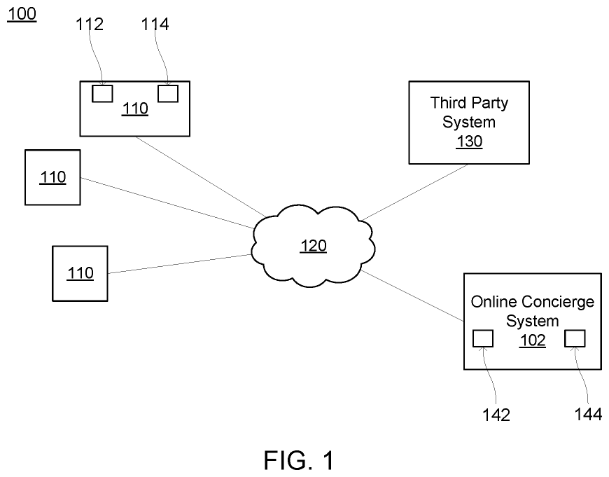

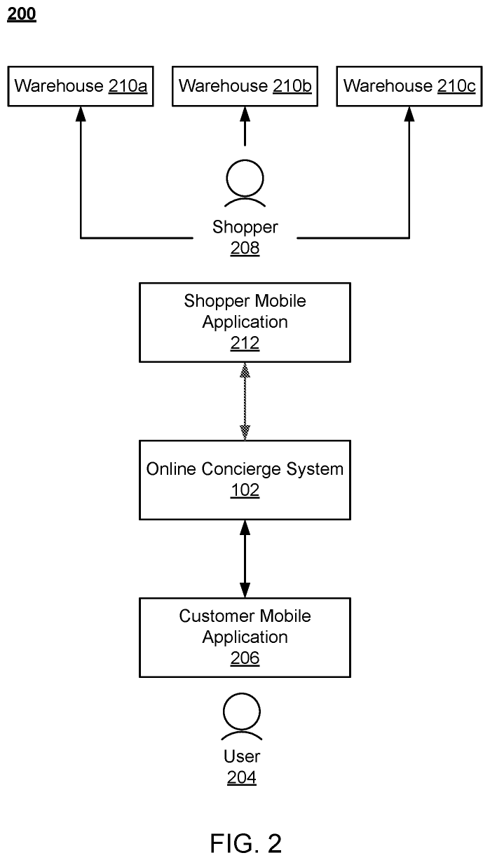

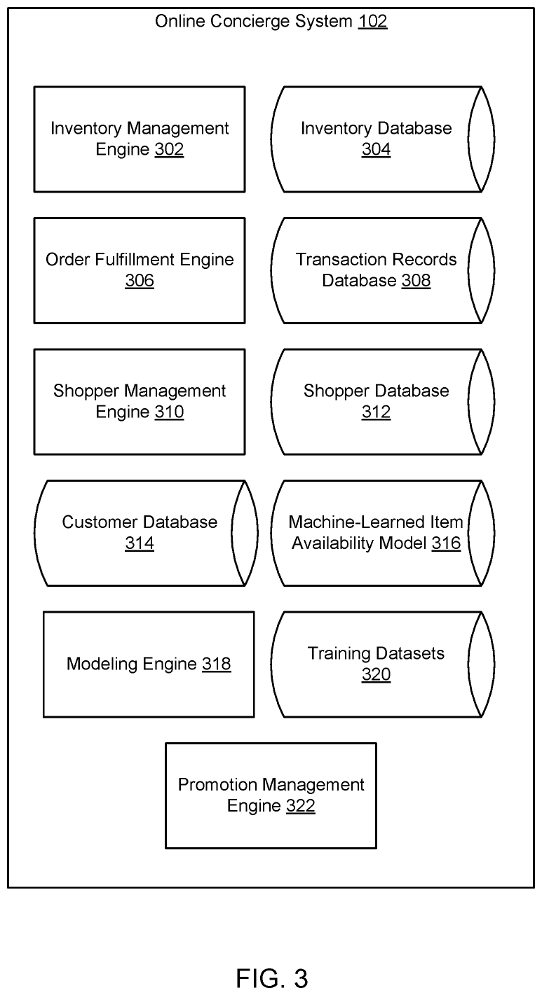

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

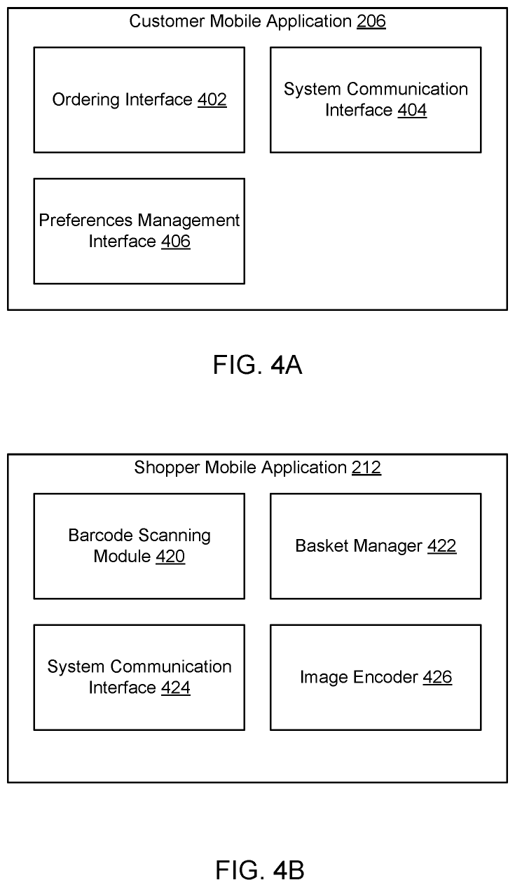

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as content, ads, or information about an application provided by the third party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described herein in relation to FIGS. 2-6. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device, a third party system 130, or the online concierge system 102 may be special purpose computing devices configured to perform specific functions, as further described below in conjunction with FIGS. 2-6, and may include specific computing components such as processors, memories, communication interfaces, and/or the like.

### System Overview

FIG. 2 illustrates an environment 200 of an online platform, such as an online concierge system 102, according to one embodiment. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one embodiment, shoppers 208 make use of a shopper mobile application 212 which is configured to interact with the online concierge system 102.

FIG. 3 is a diagram of an online concierge system 102, according to one embodiment. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and so on. In one embodiment, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210. different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which items are available at which warehouse 210. The order fulfillment engine 306 may supplement the item availability information from the inventory database 304 with an item availability predicted by the machine-learned item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one embodiment, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application 106. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one embodiment, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one embodiment, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses, and the proximity to the delivery location. The shopper management engine ell) then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on.

In various embodiments, the order fulfillment engine 306 determines whether to delay display of a received order to shoppers for fulfillment by a time interval. In response to determining to delay the received order by a time interval, the order fulfillment engine 306 evaluates orders received after the received order and during the time interval for inclusion in one or more batches that also include the received order. After the time interval, the order fulfillment engine 306 displays the order to one or more shoppers via the shopper mobile application 212; if the order fulfillment engine 306 generated one or more batches including the received order and one or more orders received after the received order and during the time interval, the one or more batches are also displayed to one or more shoppers via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user or included in received delivery orders. A single machine-learned item availability model 316 is used to predict the availability of any number of items.

The machine-learned item availability model 316 can be configured to receive as inputs information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the item availability model 316.

The machine-learned item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 316 may be updated and adapted following retraining with new training datasets 320. The machine-learned item availability model 316 may be any machine learning model, such as a neural network, boosted tree, gradient boosted tree, or random forest model. In some examples, the machine-learned item availability model 316 is generated from XGBoost algorithm. The item probability generated by the machine-learned item availability model 316 may be used to determine instructions delivered to the user 204 and/or shopper 208.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include an item type associated with the item. For example, if the item is a particular brand of an item, then the item type will be a generic description of the item type, such as “milk” or “eggs.” The item type may affect the item availability, since certain item types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the item is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

The promotion management engine 322 controls delivery of promotions in the online concierge system 102. The promotion management engine 322 may facilitate online auctions that award impression opportunities to content providers based on submitted bids. Furthermore, the promotion management engine 322 controls pacing of participation in auctions for different content campaigns. Here, the promotion management engine 322 may obtain predictions for item availability from the machine-learned item availability model 316 and submit bids only for eligible promotion opportunities when relevant items are predicted to be available.

In an embodiment, the paced spending model applied by the promotion management engine 322 beneficially operates to pace spending of content campaigns to avoid exhausting budgets of content campaigns early in the day. In the absence of such a pacing model, content providers may miss valuable opportunities to reach customers, especially customers in certain geographic regions or customers prone to shopping later in the day. The paced spending model furthermore helps avoid situations where content providers disproportionally pay increased prices for bids in the early part of the day and encounter significantly lower competition later in the day when many content providers have exhausted their daily budgets.

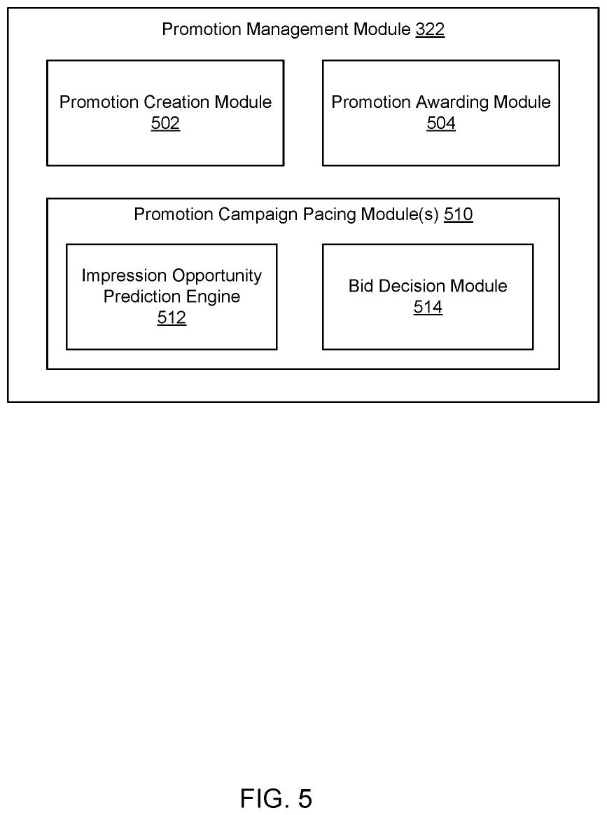

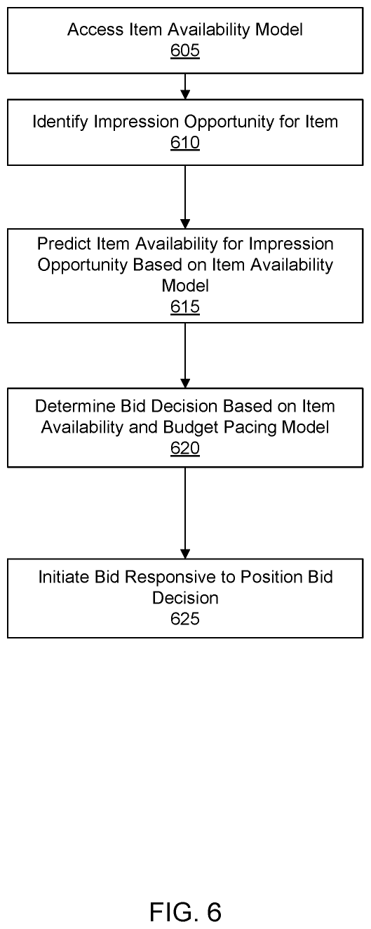

Moreover, the promotion management engine 322 operates to improve the value of content campaigns by limiting promotions to items that are predicted to be in-stock. This beneficially improves the positive impact of such content campaigns for content providers while also providing a better experience for customers. Because the online concierge system 102 has access to a wide range of item availability information across multiple retailers and geographic areas, it can access a significant amount of item availability data and use a machine learning approach to generate robust predictions of item availability for a wide range of items. An embodiment of a promotion management engine 322 is described in further detail with respect to FIGS. 5-6 below.

### Customer Mobile Application

FIG. 4A is a diagram of the customer mobile application (CMA) 206, according to one embodiment. The CMA 206 includes an ordering interface 402, which provides an interactive interface with which the user 104 can browse through and select items and place an order. The CMA 206 also includes a system communication interface 404 which, among other functions, receives inventory information from the online shopping concierge system 102 and transmits order information to the system 102. The CMA 206 also includes a preferences management interface 406 which allows the user 104 to manage basic information associated with his/her account, such as his/her home address and payment instruments. The preferences management interface 406 may also allow the user to manage other details such as his/her favorite or preferred warehouses 210, preferred delivery times, special instructions for delivery, and so on.

Shopper Mobile Application

FIG. 4B is a diagram of the shopper mobile application (SMA) 212, according to one embodiment. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 108 to manually enter information describing an item (such as its serial number, SKU, quantity and/or weight) if a barcode is not available to be scanned. SMA 212 also includes a basket manager 422 which maintains a running record of items collected by the shopper 208 for purchase at a warehouse 210. This running record of items is commonly known as a “basket.” In one embodiment, the barcode scanning module 420 transmits information describing each item (such as its cost, quantity, weight, etc.) to the basket manager 422, which updates its basket accordingly. The SMA 212 also includes a system communication interface 424 which interacts with the online shopping concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out.

### Promotion Management Engine

FIG. 5 is a block diagram illustrating an example embodiment of a promotion management engine 322. The promotion management engine 322 includes a promotion creation module 502, a promotion awarding module 504, and one or more content campaign pacing modules 510, which may include an impression opportunity prediction module 512 and a bid decision module 514. In alternative embodiments, the promotion management engine 322 includes additional or different modules.

The promotion creation module 502 identifies and creates opportunities for impressions of content in the online concierge system 102. In an embodiment, an impression opportunity is created each time a customer performs a search in the customer mobile application 206. In this case, the promotion may involve an opportunity for a specific content provider to have their item appear more prominently in the search results provided to the customer than without the promotion. For example, in an embodiment, the top slot or top few slots in the search results may be reserved for promoting relevant items from content providers that win the promotional opportunity. In another embodiment, the promotional opportunity may promote an item in a promotional space in the customer mobile application 206 separate from the search results. For example, an impression opportunity may be awarded to present an ad banner on the side of the search results or in another predefined screen location. In further embodiments, the promotion creation module 502 may create promotion opportunities for delivering promotions externally to the customer mobile application 206. For example, promotions may be delivered via push notification, via text message, via email, or via other electronic communication mechanisms.

In an embodiment, an impression opportunity is associated with a specific impression time that specifies when the promotion will be presented. Impression opportunities may furthermore include various parameters that constrain the types of content providers and/or types of items that can be awarded the impression opportunity. For example, promotions presented in response to search queries may be limited to items reasonably relevant to the search query.

The promotion awarding module 504 awards each created impression opportunity to a particular content campaign of a content provider. In an embodiment, the promotion awarding module 504 may conduct an automated online auction that obtains bids from multiple participating content campaigns and selects one or more winning bids. Here, bid submissions may be performed automatically based on participation parameters associated with each content campaign as further described below. The decision to award an impression opportunity to a particular content campaign may be based on various factors including the bid amount, the relevance of the item sought to be promoted, the history of promotion awards, or other factors.

In an embodiment, each content campaign may be associated with a single content provider. Alternatively, a single content provider may have multiple different content campaigns relating to different types of items, different geographic areas, different types or timing of promotion opportunities, or other variables. In this case, the multiple different content campaigns may independently submit bids for relevant impression opportunities.

The content campaign pacing module 510 controls pacing of participation in impression opportunities by a content campaign. For example, the content campaign pacing module 510 may generate decisions of whether or not to participate in bidding for a particular impression opportunity based in part on a goal of pacing spending of an overall promotion budget associated with the content campaign over a predefined budget period (e.g., a daily budget period). In an embodiment, a separate instance of the content campaign pacing module 510 may execute for each content campaign. Alternatively, an instance of the content campaign pacing module 510 may be shared between multiple content campaigns.

In an embodiment, the content campaign pacing module 510 comprises an impression opportunity prediction module 512 and a bid decision module 514. In alternative embodiments, the content campaign pacing module 510 comprises different or additional modules.

The impression opportunity prediction module 512 predicts a distribution of eligible impression opportunities for a content campaign over a predefined budget period (e.g., a daily budget period). The impression opportunity prediction module 512 may generate the predicted distribution based on historical data specifying historical impression opportunities for that content campaign and/or similar content campaigns. For example, the impression opportunity prediction module 512 may determine an average number of impression opportunities that have historically been available to similarly configured content campaigns in each of a set of M sub-periods (e.g., minutes or hours) during an overall budget period (e.g., a single day).

The predicted distribution of eligible impression opportunities may be limited to impression opportunities for eligible items that are expected to be available during the corresponding sub-period. Here, the impression opportunity prediction module 512 may interface with the machine-learned item availability model 316 to predict items that will be available during each sub-period throughout the budget period and then generate the distribution based only on eligible impression opportunities for items predicted to be available at the relevant time. In this embodiment, the impression opportunity prediction module 512 does not submit bids for impression opportunities during time periods where the relevant item is predicted to be unavailable.

In an embodiment, the predicted distribution of impression opportunities may be specified as a proportion (e.g., a percentage) of a count of predicted eligible impression opportunities in each sub-period relative to a total count of predicted eligible impression opportunities for the budget period. For example, a budget period may be divided into M sub-periods and a density function for each of the M sub-periods may be computed as:

Pₘ=num_eligible_windowsₘ/num_eligibles_period

where Pₘ is the proportion for a sub-period m, num_eligibles_windowₙ is the count of predicted impression opportunities for eligible items in the sub-period m, and num_eligibles_period is the count of the predicted impression opportunities for eligible items in the full budget period. For example, for a 24-hour budget period comprising M=24 sub-periods, the distribution P indicates on an hour-by-hour basis how the predicted eligible impression opportunities are distributed throughout the day for a given content campaign. Such a distribution may be informative of whether impression opportunities for a content campaign are more likely to occur, for example, in the morning, in the evening, or elsewhere during the day.

In an embodiment, the impression opportunity prediction module 512 may determine the distribution P by separately predicting the count of the predicted impression opportunities for eligible items in the full budget (num_eligibles_period) and the counts of respective impression opportunities for eligible items in each of the sub-periods m (num_eligible_windowsₘ). Here, each of these values may be predicted as an average or other function of the relevant historically observed opportunities. In another embodiment, the counts (num_eligibles_period, num_eligible_windowsₘ) may be predicted by respective machine learning models using regression-based learning techniques, supervised learning techniques, or other machine learning approaches. In some embodiments, the prediction models may be trained in part based on external factors independent of the historical data (e.g., economic factors, weather, pricing data, etc.) that may enable more accurate predictions.

Alternatively, the impression opportunity prediction module 512 may directly predict the distribution of proportions without necessarily first predicting the specific total counts for the sub-periods and the full budget period. For example, the impression opportunity prediction module 512 may directly predict the proportions as a function (e.g., an average) of historically observed proportions or by applying a machine learning model trained on the historically observed proportions (and optionally based on other external factors).

In an embodiment, the historical impression data used to predict the distribution of eligible impression opportunities may be filtered to generate predictions using only the most relevant historical data for a specific situation. For example, the impression opportunity prediction module 512 may filter the historical impression data and base the predictions only on data in a relevant time windows (e.g., using data only in a recent time window and/or using only data from the same day of the week as the periods being predicted).

The bid decision module 514 determines, for a content campaign, a bid decision for an impression opportunity dependent on the predicted item availability and a paced spending model that operates to pace a spending budget associated with the content campaign over the budget period. The bid decision may include a decision of whether or not to throttle participation for an impression opportunity. For example, a content campaign may forgo participation in an auction when a decision to throttle is made. Alternatively, throttling may involve reducing the aggressiveness of participation (e.g., lowering the bid amounts) without necessarily foregoing participation entirely.

The bid decision module 514 may access the machine-learned item availability model 316 to determine a likelihood of a relevant item associated with the content campaign being available at the impression time. If the bid decision module 514 assesses a relevant item is not available (i.e., it is not eligible for the impression opportunity), then the bid decision module 514 determines not to submit a bid.

Otherwise, if a relevant item is predicted to be available, the bid decision module 514 determines its participation in the auction based on the paced spending model. In one embodiment, for a given impression opportunity at a specified impression time, the bid decision module 514 obtains an observed cumulative spend for the content campaign during a portion of the budget period prior to the impression time. The bid decision module 514 also determines a desired cumulative spend for the content campaign at the impression time based on the distribution of impression opportunities and a set budget for the content campaign during the budget period. Here, the desired proportion of cumulative spend may mirror the cumulative proportion of eligible impression opportunities that were expected to occur prior to the upcoming impression time. For example, if 53% of eligible impression opportunities during the budget period are predicted to have already occurred, the bid decision module 514 may pace spending such that the desired cumulative spend at the impression time is 53%. The bid decision module 514 then generates the bid decision based on a comparison between the observed cumulative spend and the desired cumulative spend. Thus, in the example above, the bid decision module 514 may determine that the content campaign will submit a bid for the impression opportunity when the cumulative spend prior to the impression time is less than 53% of the total budget for the budget period, and otherwise determine to throttle participation (e.g., determine not to participate).

In an example implementation, the bid decision module 514 determines a cumulative density associated with each sub-period m as follows:

$${DCD}_{m} = {\sum }_{i = 0 , m - 1} {P}_{i}$$

where DCDₘ is the density function representing the cumulative predicted proportions of eligible impression opportunities occurring prior to the mth sub-period. In an embodiment, the bid decision module 514 may compute and store in advance, an array of density functions DCD for all sub-periods in the budget period. The bid decision module 514 may update the array each time the predicted distribution P or parameters controlling the lengths of the budget period and/or sub-periods are updated. The relevant value may then be accessed when the impression opportunity arises. Alternatively, the density function may DCDₘ for a given sub-period m be computed substantially in real-time when the impression opportunity is identified for a sub-period m.

Upon identifying an eligible impression opportunity at an impression time t, the bid decision module 514 computes a desired cumulative density function CDF for the impression time t within the mth sub-period as follows:

CDF(t)=DCDₘ+(DCDₘ₊₁−DCDₘ)*(t−time(m))/(time(m+1)−time(m))

for m≤t≤m+1

where t is the impression time within a sub-period m and time(m) represents a start time of the sub-period m. Here, the cumulative density function (CDF) represents the proportion of the desired cumulative spend for the content campaign during the budget period prior to the impression time t.

In an embodiment, the bid decision module 514 may convert the cumulative density function CDF to a dollar amount representing the desired cumulative spend at any given time t as follows:

Desired_spend(t)=CDF(t)*Budget

where Budget represents the budget for the full budget period.

The bid decision module 514 compares the desired cumulative spend Desired_spend to the observed cumulative spend Observed_Spend to determine whether or not to throttle participation. For example, the bid decision module 514 determines not to throttle participation (i.e., determines to submit a bid) when:

Desired_Spend>Observed_Spend

The bid decision module 514 determines to throttle participation when:

Desired_Spend<Observed_Spend

Alternatively, instead of comparing desired and observed spend amounts, the bid decision module 514 may instead compare the cumulative density function CDF(t) with an observed proportion of the budget spent prior to the impression time. The bid decision module 514 may similarly make a participation decision based on the comparison of the respective desired and observed proportions.

FIG. 6 is an example embodiment of a flowchart illustrating a method for managing paced spending of a content campaign in association with an impression opportunity. The content campaign pacing module 510 accesses 605 an item availability model 316 trained to predict availability likelihoods of items in an inventory of an online concierge system 102 as described above. The content campaign pacing module 510 identifies 610 an impression opportunity for a content campaign for promoting an item associated with the content campaign at an impression time. The impression opportunity may comprise, for example, an ad auction or other offer that allows entities to bid on a promotional opportunity. The content campaign pacing module 510 obtains 615, based on the item availability model, a predicted item availability for the item at the impression time (e.g., from the machine-learned item availability model 316). The content campaign pacing module 510 determines 620 a bid decision for the impression opportunity that is dependent on the predicted item availability and a paced spending model that operates to pace a spending budget associated with the content campaign over the budget period. For example, for an eligible impression opportunity where the item is predicted to be available, the content campaign pacing module 510 may compare the cumulative spend for the content campaign prior to the impression time against a desired spend for the content campaign prior to the impression time. Here, the desired spend is computed based on the predicted distribution of predicted impression opportunities during different sub-periods of the budget period and a total budget for the budget period. The content campaign pacing module 510 initiates 625 a bid responsive to a positive bid decision. For example, the content campaign pacing module 510 may initiate the bid when the observed spend prior to the impression time is less than the desired spend derived from the pacing model. Otherwise, the content campaign pacing module 510 may throttle participation (e.g., by not submitting a bid for the impression opportunity).

### Additional Considerations

The foregoing description of the embodiments of the invention has been presented for the purpose of illustration; it is not intended to be exhaustive or to limit the invention to the precise forms disclosed. Many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
at a computer system comprising at least one processor and memory:
obtaining an item availability model trained to predict availability likelihoods of items in an inventory of an online concierge system that processes requests from customers via a customer application, assigns the requests to available shoppers, and generates routing instructions via a shopper application for facilitating deliveries by the shoppers to the customers in accordance with the requests;
identifying an impression opportunity for a content campaign to promote an item associated with the content campaign at an impression time within an impression time window;
predicting based on the item availability model, a predicted item availability for the item at the impression time;
determining a bid decision for the impression opportunity dependent on the predicted item availability and a paced spending model that operates to pace a spending budget associated with the content campaign over a budget period; and
causing the content campaign to enter a bid for the item responsive to a positive participation decision.

2. The method of claim 1, wherein determining the bid decision comprises:
predicting, for the content campaign, a distribution of impression opportunities for available items in each of a plurality of budget sub-periods during the budget period;
obtaining an observed cumulative spend for the content campaign during a portion of the budget period prior to the impression time;
determining, a desired cumulative spend for the content campaign during the portion of the budget period prior to the impression time based on the distribution of impression opportunities and a budget for the content campaign during the budget period; and
generating the bid decision based on a comparison between the observed cumulative spend and the desired cumulative spend.

3. The method of claim 2, wherein the distribution of the impression opportunities comprises respective predicted proportions of total impression opportunities occurring in each of the budget sub-periods.

4. The method of claim 2, wherein predicting the distribution of impression opportunities comprises:
predicting the distribution based on historical data indicative of historical impression opportunities.

5. The method of claim 2, wherein predicting the distribution of impression opportunities comprises:
predicting the distribution based on a prediction model that receives historical impression opportunities and one or more external factors predicted to influence the distribution.

6. The method of claim 2, wherein determining the desired cumulative spend comprises:
determining, based on the distribution of impression opportunities, a cumulative density function representing a proportion of impression opportunities for the budget period predicted to occur prior to the impression time; and
determining the desired cumulative spend as a product of the budget for the budget period and the cumulative density function.

7. The method of claim 1, wherein the item availability model is trained based on historical item availability data associated with items from a plurality of warehouses across a geographic area.

8. The method of claim 1, wherein the budget period comprises a daily period.

9. A computer program product comprising a non-transitory computer readable storage medium having instructions encoded thereon that, when executed by a processor, cause the processor to perform steps including:
obtaining an item availability model trained to predict availability likelihoods of items in an inventory of an online concierge system that processes requests from customers via a customer application, assigns the requests to available shoppers, and generates routing instructions via a shopper application for facilitating deliveries by the shoppers to the customers in accordance with the requests;
identifying an impression opportunity for a content campaign to promote an item associated with the content campaign at an impression time within an impression time window;
predicting based on the item availability model, a predicted item availability for the item at the impression time;
determining a bid decision for the impression opportunity dependent on the predicted item availability and a paced spending model that operates to pace a spending budget associated with the content campaign over a budget period; and
causing the content campaign to enter a bid for the item responsive to a positive participation decision.

10. The computer program product of claim 9, wherein determining the bid decision comprises:
predicting, for the content campaign, a distribution of impression opportunities for available items in each of a plurality of budget sub-periods during the budget period;
obtaining an observed cumulative spend for the content campaign during a portion of the budget period prior to the impression time;
determining, a desired cumulative spend for the content campaign during the portion of the budget period prior to the impression time based on the distribution of impression opportunities and a budget for the content campaign during the budget period; and
generating the bid decision based on a comparison between the observed cumulative spend and the desired cumulative spend.

11. The computer program product of claim 10, wherein the distribution of the impression opportunities comprises respective predicted proportions of total impression opportunities occurring in each of the budget sub-periods.

12. The computer program product of claim 10, wherein predicting the distribution of impression opportunities comprises:
predicting the distribution based on historical data indicative of historical impression opportunities.

13. The computer program product of claim 10, wherein predicting the distribution of impression opportunities comprises:
predicting the distribution based on a prediction model that receives historical impression opportunities and one or more external factors predicted to influence the distribution.

14. The computer program product of claim 10, wherein determining the desired cumulative spend comprises:
determining, based on the distribution of impression opportunities, a cumulative density function representing a proportion of impression opportunities for the budget period predicted to occur prior to the impression time; and
determining the desired cumulative spend as a product of the budget for the budget period and the cumulative density function.

15. The computer program product of claim 9, wherein the item availability model is trained based on historical item availability data associated with items from a plurality of warehouses across a geographic area.

16. The computer program product of claim 9, wherein the budget period comprises a daily period.

17. A computer system comprising:
a processor; and
a non-transitory memory storing instructions that, when executed by the processor, cause the computer system to perform steps including:
obtaining an item availability model trained to predict availability likelihoods of items in an inventory of an online concierge system that processes requests from customers via a customer application, assigns the requests to available shoppers, and generates routing instructions via a shopper application for facilitating deliveries by the shoppers to the customers in accordance with the requests;
identifying an impression opportunity for a content campaign to promote an item associated with the content campaign at an impression time within an impression time window;
predicting based on the item availability model, a predicted item availability for the item at the impression time;
determining a bid decision for the impression opportunity dependent on the predicted item availability and a paced spending model that operates to pace a spending budget associated with the content campaign over a budget period; and
causing the content campaign to enter a bid for the item responsive to a positive participation decision.

18. The computer system of claim 17, wherein determining the bid decision comprises:
predicting, for the content campaign, a distribution of impression opportunities for available items in each of a plurality of budget sub-periods during the budget period;
obtaining an observed cumulative spend for the content campaign during a portion of the budget period prior to the impression time;
determining, a desired cumulative spend for the content campaign during the portion of the budget period prior to the impression time based on the distribution of impression opportunities and a budget for the content campaign during the budget period; and
generating the bid decision based on a comparison between the observed cumulative spend and the desired cumulative spend.

19. The computer system of claim 18, wherein the distribution of the impression opportunities comprises respective predicted proportions of total impression opportunities occurring in each of the budget sub-periods.

20. The computer system of claim 18, wherein predicting the distribution of impression opportunities comprises:
predicting the distribution based on historical data indicative of historical impression opportunities.
